(19) United States
(12) Patent Application Publication
(10) Pub. No.: US 2021/0148145 A1
(43) Pub. Date: May 20, 2021

(54) LINK BODY, FOLDING STRUCTURE PROVIDED WITH SAME LINK BODY, AND SEPARATING MEMBER USED FOR SAME FOLDING STRUCTURE

(71) Applicant: Hidehiko FUKUSHIMA, Yokohama-shi (JP)

(72) Inventor: Hidehiko FUKUSHIMA, Yokohama-shi (JP)

(21) Appl. No.: 17/157,421

(22) Filed: Jan. 25, 2021

Related U.S. Application Data
(62) Division of application No. 16/427,104, filed on May 30, 2019.
Application No. 16/427,104 is a division of application No. 15/537,387, filed on Jun. 16, 2017, now abandoned.

(30) Foreign Application Priority Data
Dec. 19, 2014 (JP) 2014-258116

(51) Int. Cl. E05D 1/06

(52) U.S. Cl. CPC E05D 1/06; B43L 1/008

(57) ABSTRACT

Superior usability is provided and the degree of freedom in terms of use is enhanced.

A plurality of link members A1 and A2 include at least one of linear edges A12 and A22 at the peripheral edge of a facing surface A10 or A20 that faces in a folded state. At least one of the adjacent link members A1 and A2 is a magnet, and the other is a material attracted by the magnet. A link body A is formed of the link members A1 and A2 that are linked by the attracting force due to the magnetic force of the link members A1 and A2, of which the linear edges A12 and A22 are aligned.

This application is a Continuation Application of U.S. application Ser. No. 16/427,104, filed on May 30, 2019, which is a Divisional Application of U.S. application Ser. No. 15/537,387, filed on Jun. 16, 2017, which is a U.S. National Stage Application of PCT Application No. PCT/JP2015/085192, filed on Dec. 16, 2015, which claims priority from Japanese Application No. 2014-258116, filed on Dec. 19, 2014, the contents of which are incorporated by reference.

### TECHNICAL FIELD

The present invention relates to a link body that links a plurality of members to each other to be rotatable, a folding structure provided with the same link body, and a separating member used for the same folding structure.

### BACKGROUND ART

Conventionally, a folding structure in which a plurality of members are rotatably linked by a link member and in which a folded state where members overlap each other and a developed state where members are spread are established in a switchable manner by rotation about the link member has been known in a board set described in PTL 1 below.

In the board set described in PTL 1, the member is a tabular panel (whiteboard) provided with a writing surface, and the tabular panels are configured to be foldable and developable by the edges of the tabular panels being linked by a band-shaped link member formed of a flexible material such as rubber.

### CITATION LIST

### Patent Literature

### [PTL 1] Japanese Patent Application Laid-open Publication No. 2012-101481

### SUMMARY OF INVENTION

### Technical Problem

According to the conventional technique in PTL 1, there is provided a board set that can be used with the tabular panel developed to a free relative angle without use of any complex hinge structure, be folded and stored in a compact manner when unnecessary, and be carried.

However, since the link member is a band-shaped one formed of a flexible material such as rubber in the conventional technique in PTL 1, there has been a problem that repeated folding motions and developing motions cause degradation, such that the link member is cut and the tabular panels are separated.

When the tabular panels are separated, not only the plurality of tabular panels are unable to stand by themselves upon being developed as one board, but also it has been necessary to hold the tabular panels in an overlapped state by wrapping a rubber band, string, or the like around the overlapped tabular panels or clipping with a clip, when the tabular panels are to be overlapped and carried.

Since the link member is fixed to link the tabular panels at the time of manufacturing in this board set, there has been a problem that, in the case where the tabular panels are developed for writing or in the case where writing is done for each tabular panel, no measure is available to address the problem on the spot even if the number of tabular panels set at the time of manufacture is insufficient.

Since the board set is used in a state where the linked state of the tabular panels is held by the link member, provided that the link member is not cut, the tabular panels cannot be used one by one. There has been a problem that, for example, handing out one tabular panel to each of a plurality of people for writing or for checking of descriptions differing in content for each one is not feasible.

That is, with the board set of the conventional technique in PTL 1, there has been a problem that normal use of the board set, such as the tabular panels being developed to a free relative angle, folded and stored in a compact manner when unnecessary, or carried, is prevented by cutting of the link member, and there has been a problem of a low degree of freedom in the form of use, such as the number of tabular panels not being able to be increased or the tabular panels not being able to be divided one by one.

Addressing such problems is one example of a task of the present invention. That is, an object of the present invention is for a plurality of members to be developable to a free relative angle, able to be folded and stored in a compact manner when unnecessary, and able to be carried, for the number of members to be freely increasable, for the plurality of members to be dividable, accordingly for superior usability to be provided and the degree of freedom in terms of use to be enhanced, and the like.

### Solution to Problem

In order to achieve such an object, the present invention is provided with at least a configuration below.

A link body in which a plurality of link members are provided, peripheral edges of the plurality of link members are linked each other such that the link members are relatively rotatable, and a folded state where the link members overlap and a developed state where the link members are spread are established in a switchable manner by rotating the link members, the link body is configured such that at least one of the link members overlapping and adjacent to the other is a magnet and the other is a material attracted by the magnet, and a plurality of link members are mutually linked by an attracting force of a magnetic force through, in a state where linear edges provided along peripheral edges of facing surfaces that face each other in the folded state are aligned, contact of the facing surfaces.

A folding structure provided with the link body described above, wherein the folding structure is provided with a plurality of separating members each provided with the link member, the separating member includes at least one linear edge at a peripheral edge of a facing surface that faces in a folded state, and the link member is arranged such that the linear edge of the link member is aligned with the linear edge of the separating member.

A separating member used for the folding structure described above, wherein the link member provided to the separating member is a magnet.

### Advantageous Effects of Invention

Including such a feature, the present invention provides an effect below. That is, the plurality of members can be developed to a free relative angle, folded and stored in a compact manner when unnecessary, and carried. Further, the number of the members can be increased freely, and also the plurality of members can be divided. Accordingly, superior usability is provided, and the degree of freedom in terms of use is enhanced.

### BRIEF DESCRIPTION OF DRAWINGS

FIG. 1 is a perspective view of a link body of one embodiment according to the present invention.

FIG. 2 is a sectional view on line (2)-(2) in FIG. 1.

FIG. 3 is a perspective view of a whiteboard of one embodiment according to the present invention.

FIG. 4 is a front view of FIG. 3.

FIG. 5 is a sectional view on line (5)-(5) in FIG. 4.

FIG. 6 is a front view showing the developed state of the whiteboard.

FIG. 7 is a perspective view showing a state where the whiteboard is developed and stood.

FIG. 8 is a perspective view of a board member.

### DESCRIPTION OF EMBODIMENTS

In a link body of the present invention, all the plurality of link members are preferably magnets.

In a folding structure of the present invention, the plurality of separating members are preferably provided with the plurality of link bodies respectively.

It is preferable that the plurality of separating members are provided respectively with two of the link bodies that are magnets and that the link bodies are arranged to be magnetic pole surfaces differing from each other on the same facing surfaces of the separating members.

It is preferable that the separating member is provided with a storage recessed part to store the link member and that the storage recessed part is formed in a shape to suit the peripheral edge shape of the link body, from the linear edge of the separating member toward another peripheral edge of the separating member excluding the linear edge.

Further, it is preferable that the thickness of the link body and the thickness of the separating member are same and that the link body is stored in the storage recessed part such that the facing surface of the link body and the facing surface of the separating member are the flush with each other.

The magnet used for the separating member of the link body according to the present invention is preferably a neodymium magnet of strong magnetic force.

The folding structure according to the present invention can be carried out where a hard tabular separating member is provided and there are the plurality of separating members, such as in, for example, a whiteboard, a colored board, an album, a photo frame, a picture book, or a picture-story board.

On a whiteboard or a colored board, one can write with a whiteboard marker using ink that can be erased by wiping. An album, a photo frame, a picture book, or a picture-story board may allow for writing with a whiteboard marker and allow for erasing by wiping, as with a whiteboard or a colored board.

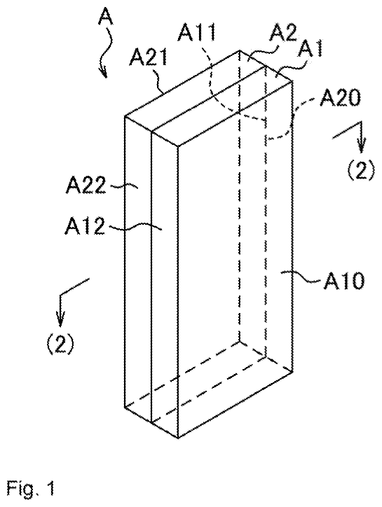

An embodiment for the link body, folding structure, and separating member according to an embodiment of the present invention will be described below on the basis of FIG. 1 to FIG. 8. The embodiment will be described with the folding structure as a whiteboard and the separating member as a board member.

FIG. 1 is a perspective view showing the configuration of a link body A, and a pair of link members A1 and A2 formed of a neodymium magnet are provided.

The link members A1 and A2 are formed to be tabular in a rectangle with the same area and the same thickness with each other. The link members A1 and A2 are linked by contacting each other in a state an N pole facing surface (hereinafter referred to as N pole surface) A10 set in one of front and back surfaces of the two and an S pole facing surface (hereinafter referred to as S pole surface) A21 set in the other are made to face each other and linear edges A12 and A22 on four sides of the link members A1 and A2 are aligned, contact is made to link the same (a folded state).

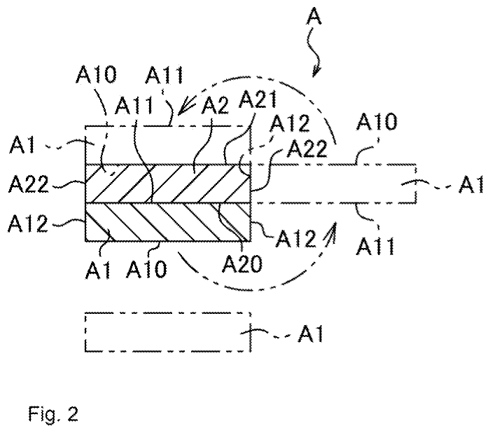

As shown in FIG. 2, by rotating such a link body A to draw apart the link members A1 and A2 about the linear edges A12 and A22 as the axis of rotation from the folded state, the link body A can be brought to a developed state.

The rotating motion of the link members A1 and A2 is performed in a state where the linear edges A12 and A22 are in contact with each other through the attracting force due to the magnetic force. With a rotation in a direction to draw apart the link members A1 and A2, assuming the folded state as 0□, the angle between the link members A1 and A2 gradually increases, and the developed state of 180□ (state shown by a two-dot chain line) can be brought about in a state where the linear edges A12 and A22 are butted face to face.

Further, by rotating the link members A1 and A2 in a direction to exceed the developed state of 180□, an S pole facing surface (hereinafter referred to as S pole surface) A11 set in one of the front and back surfaces and an N pole facing surface (hereinafter referred to as N pole surface) A20 set in the other face and attract each other. Accordingly, a shift can be made to a linked state (state shown by a one-dot chain line) in the folded state of 360□.

The link members A1 and A2 can be separated (in a state shown by a three-dot chain line) by being pulled apart against the attracting force due to the magnetic force.

In the link body A shown as an example, both of the link members A1 and A2 are configured of a neodymium magnet. However, the present invention is not limited to a neodymium magnet, and a magnet other than a neodymium magnet may be employed. It may be such that one of the link members A1 and A2 is a magnet of various types including a neodymium magnet and the other is a magnet other than a neodymium magnet or a magnetic body of metal or the like attracted by the magnetic force of a magnet of various types including a neodymium magnet.

The link members A1 and A2 shown as an example are rectangular. However, in the present invention, it suffices that the shape includes at least one linear edge A12 or A22.

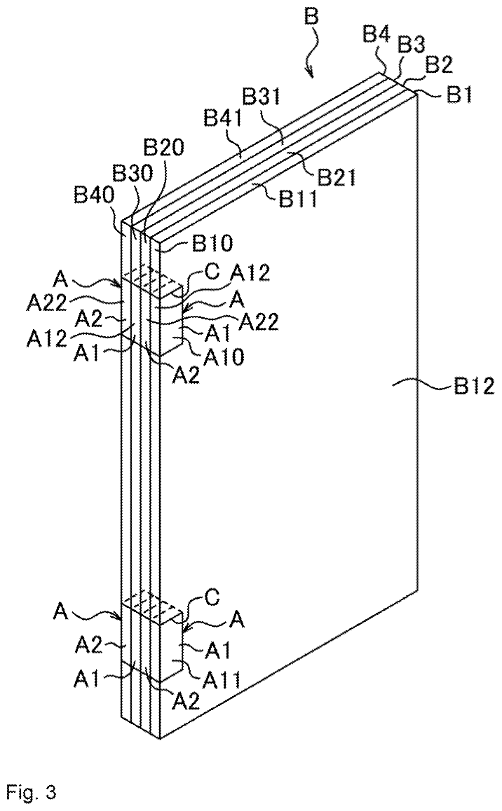

FIG. 3 is a perspective view showing the configuration of a whiteboard B provided with the link body A. There are included four board members B1 to B4, and the board members B1 to B4 are linked via the link body A.

Two link members A1 are attached to each of the board members B1 and B3, and link members A2 paired with the two link members A1 are attached to each of the board members B2 and B4.

The board members B1 to B4 are formed as a hard rectangular tabular material through bonding and compression of a large number of overlapped paper materials. The front and back surfaces are coated with a surface agent that allows for writing with a whiteboard marker and allows for erasing by wiping.

The board members B1 to B4 are not limited to those using a paper material. A tabular material formed of a hard material resistant to deformation such as a hard synthetic resin material, a light metal material, or a wooden material can be used. In either case, it is advisable to coat the front and back surfaces with the surface agent described above.

In each of the board members B1 to B4, a storage recessed part C to store the link member A1 or A2 is formed.

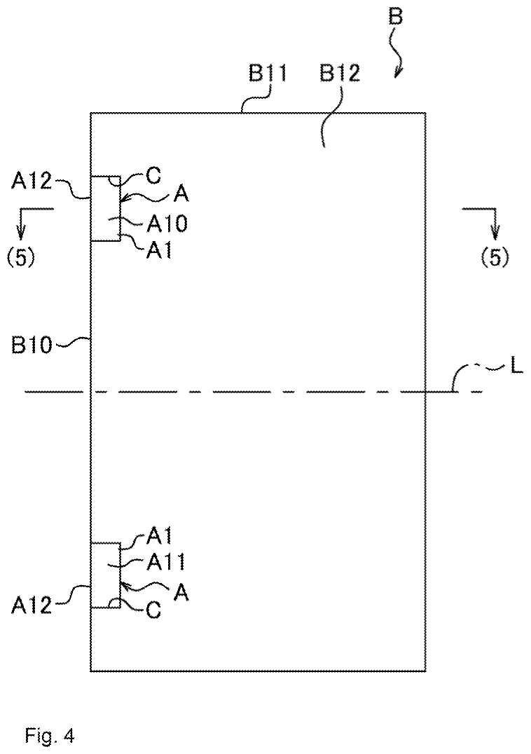

As shown in FIGS. 3 to 8, the storage recessed part C is formed in a rectangle as a shape that the link members A1 and A2 can suit and be stored in, from linear edges B10-B40 on one long side (left hand side in FIG. 4) of the board members B1 to B4 in a parallel manner to linear edges B11-B41 on the short side toward the linear edges B10-B40 on the long side facing the linear edges B10-B40, such that the linear edges A12 and A22 are flush with the linear edges B10-B40 when the link members A1 and A2 are stored.

As shown in FIG. 4, the arranged positions of the storage recessed part C are in facing position when the board members B1 to B4 are overlapped with the linear edge B10-B40 and the linear edge B11-B41 on four sides aligned and are positions that are line-symmetric about a center line L parallel to the linear edge B11-B41 as the axis of symmetry.

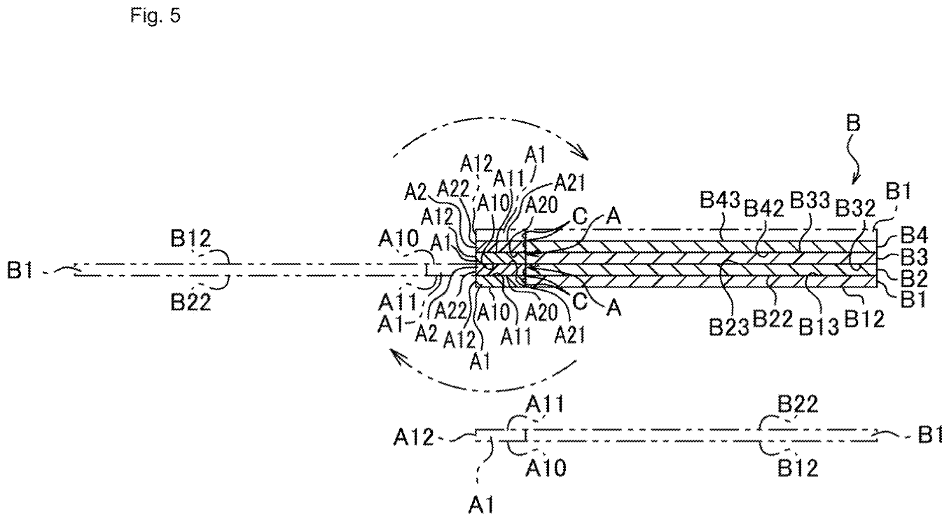

As shown in FIG. 5, the link members A1 and A2 and the board members B1 to B4 are both formed with the same thickness, such that, when the link members A1 and A2 are stored in the storage recessed part C, the N pole surfaces A10 and A20 and S pole surfaces A11 and A21 are flush with the facing surfaces B12, B13, B22, B23, B32, B33, B42, and B43 at the front and back of the board members B1 to B4.

The link members A1 and A2 stored in the storage recessed part C are held in a stored state using an adhesive, an adhesive tape, or the like.

That is, since the front and back of the board members B1 to B4 are not uneven, the board members B1 to B4 can be overlapped without causing a gap between the facing surfaces B12, B13, B22, B23, B32, B33, B42, and B43. The whiteboard B can be formed by overlapping of minimum thickness, a thickness corresponding to the number of the board members B1 to B4.

The pair of link members A1 and A2 are arranged such that the link body A is configured to extend across the board members B1 and B2 and extend across the board members B3 and B4.

Since there are four board members B1 to B4 in this embodiment, there are also a pair of the link bodies A configured of the link member A2 of the board member B2 and the link member A1 of the board member B3.

The directions of the magnetic pole surfaces of the respective two link members A1 and A2 arranged at each the board members B1 to B4 are directions differing from each other. One is the N pole surface A10, and the other is the S pole surface A11.

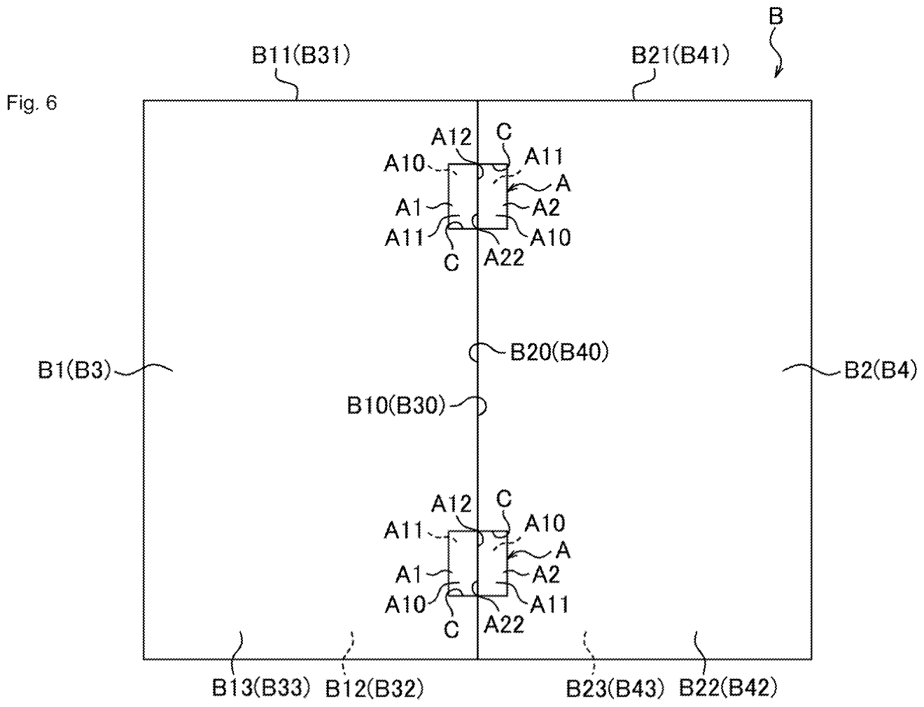

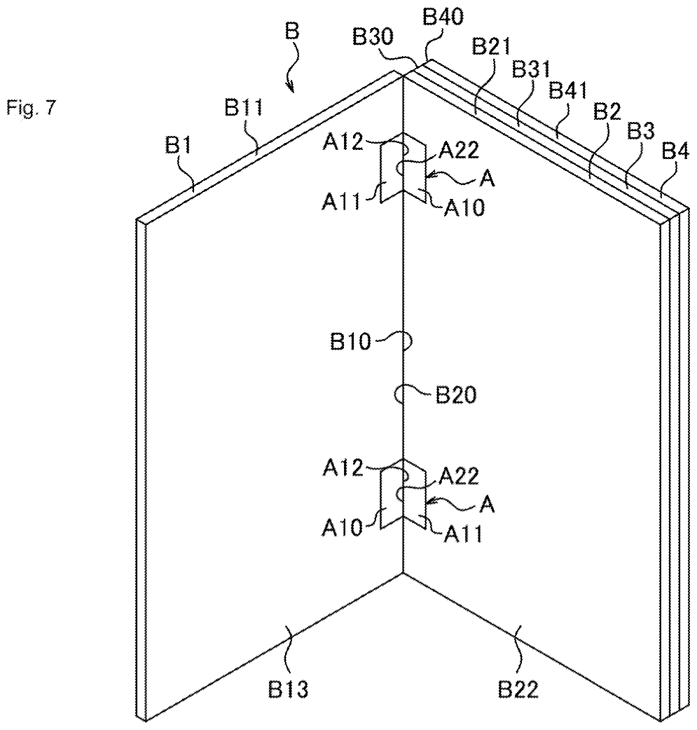

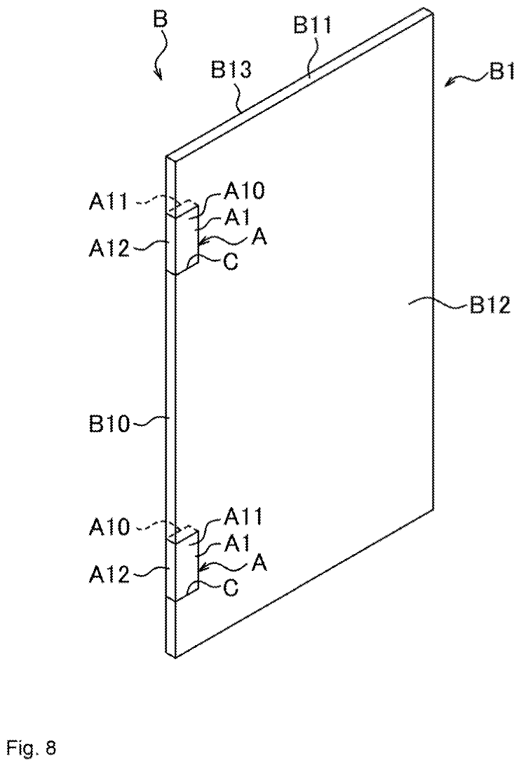

Specifically, in the link members A1 arranged at the board members B1 and B3, the magnetic pole surfaces on the facing surface B12 or B32 side are the N pole surface A10 on the upper side and the S pole surface A11 on the lower side, as shown in FIG. 3, FIG. 4, FIG. 6, FIG. 7, and FIG. 8. And the magnetic pole surfaces on the facing surface B13 or B33 side are the opposite of the magnetic pole surfaces on the facing surface B12 or B32 side.

In the link members A2 arranged at the board members B2 and B4, the magnetic pole surfaces on the facing surface B22 or B42 side are the N pole surface A10 on the upper side and the S pole surface A11 on the lower side. The magnetic pole surfaces on the facing surface B23 or B43 side are the opposite of the magnetic pole surfaces on the facing surface B22 or B42 side.

That is, when the board members B1 to B4 are overlapped to be in the folded state, as shown in FIG. 5, the link members A1 and A2 are linked by the attracting force due to the magnetic force of each other, with the N pole surface A10 and the S pole surface A11 facing each other. With the link body A formed by linking the link members A1 and A2, the board members B1 to B4 can be integrated in the folded state. By rotating the board members B1 to B4 about the linear edges A12 and A22 of the link members A1 and A2 as the axis of rotation, the board members B1 to B4 can be integrated in the developed state (shown by a two-dot chain line).

By pulling apart the link members A1 and A2 against the attracting force due to the magnetic force of the link members A1 and A2, the board members B1 to B4 can be separated.

Depending on the form of directions of the magnetic pole surfaces described above of the link members A1 and A2 arranged at the board members B1 to B4, the link members A1 and A2 can be linked by the attracting force due to the magnetic force, regardless of the front and back of the board members B1 to B4. Therefore, when linking the board members B1 to B4 in a separated state, aligning the linear edges A12 and A22 of the link members A1 and A2 and overlapping the board members B1 to B4 can surely make the N pole surface A10 and the S pole surface A11 face each other.

With such a whiteboard B, the board members B1 to B4 can be developed as if turning a page through a rotation about the linear edges A12 and A22 of the link members A1 and A2 as the axis of rotation from the overlapping folded state. And a rotation up to 360□ can change the position of the rotated board members B1 to B4 (board member B1 in FIG. 5) to the outermost side (outside of the board member B4 in FIG. 5, shown by a one-dot chain line) for a folded state.

In the folded state of the board members B1 to B4, the whiteboard B can be with an area of one of the board members B1 to B4 (see FIG. 4). And in the developed state, the whiteboard B can be with an area of two of the board members B1 to B4 (see FIG. 6). Therefore, according to the situation of use, the area of the whiteboard B can be changed.

Depending on the development angle of the rotated board members B1 to B4, the whiteboard B can be stood. Therefore, content written on the whiteboard B can be made easily viewable for an intended person and easily showable to an intended person for giving an explanation (see FIG. 7).

The whiteboard B is formed by linking the board members B1 to B4, utilizing the attracting force due to the magnetic force of the link members A1 and A2. Therefore, addition of another board member can be performed easily, and switching of the page order of the board members B1 to B4 can be done freely.

By pulling apart the link members A1 and A2 against the attracting force due to the magnetic force of the link members A1 and A2, the board members B1 to B4 can be separated. Therefore, according to the situation of use, the whiteboard B can be divided into a plurality of pieces for use, or the board members B1 to B4 can be each used as an independent whiteboard B (see FIG. 8, FIG. 8 showing the board member B1).

Utilizing the magnetic force of the link members A1 and A2, the whiteboard B in the folded state and the whiteboard B divided into a plurality of pieces can be attached to a wall surface formed of a magnetic body. Therefore, content written on the whiteboard B can be made easily viewable for an intended person and easily showable to an intended person for giving an explanation.

Aligning the linear edges A12 and A22 of the link members A1 and A2 and overlapping the board members B1 to B4 can surely make the N pole surface A10 and the S pole surface A11 face each other. Therefore, when the divided board members B1 to B4 are again made into an integrated whiteboard B, the performance can be extremely quick and easy.

With the link body A linked utilizing the attracting force due to the magnetic force of the link members A1 and A2, the board members B1 to B4 are linked to be rotatable and separable. Therefore, unevenness does not occur upon attachment to the board members B1 to B4, as with a hinge, a coil ring used for a ring binder, or the like. Moreover, a hole-opening process or a screw-fastening process can be made unnecessary.

Accordingly, without using a hinge, a coil ring, or the like that causes unevenness and requires a process at the time of attachment, the board members B1 to B4 can be overlapped in a flat state. Since the whiteboard B can be made to be a structure that can rotate 360□, storing in and taking out from a bag or sack can be performed smoothly. Moreover, since the whiteboard B can be configured of the board members B1 to B4 manufactured and overlapped one by one, the manufacturing cost of the whiteboard B can be reduced, and the mass productivity can be enhanced.

By causing a magnet portion of a general whiteboard marker provided with a magnet to be attracted by the link body A, the whiteboard marker and the whiteboard B can be carried in an integrated manner.

Thus, the plurality of board members B1 to B4 can be developed to a free relative angle, can be folded and stored in a compact manner when unnecessary, and can be carried. Further, the number of the board members B1 to B4 can be increased freely, and the plurality of board members can be divided into the plurality of whiteboards B.

Accordingly, the whiteboard B and the board members B1 to B4 can be provided in which superior usability is provided and in which the degree of freedom in terms of use is high.

With the present invention, the same function and effect as with the whiteboard B shown as an example are produced, also in the case where the folding structure is made into an album, a photo frame, a picture book, or a picture-story board, other than the whiteboard B.

Two pairs of the link bodies A of the embodiment shown as an example are provided for each adjacency of the board members B1 to B4. In the present invention, there may be one pair or three or more pairs of the link bodies A provided for each adjacency of the board members B1 to B4. In this form as well, the board members B1 to B4 can be developed as if turning a page and can be separated.

The link bodies A of the embodiment shown as an example are arranged to be the N pole surface A10 and the S pole surface A11 each on the same one of the facing surfaces of the board members B1 to B4. However, in the present invention, the arrangement may be such that the N pole surfaces A10 or the S pole surfaces A11 are on the same one of the facing surfaces of the board members B1 to B4. In such a form as well, the board members B1 to B4 can be developed as if turning a page and can be separated.

The shape of the board members B1 to B4 is not limited to a rectangle shown as an example. It suffices that the shape includes the linear edge B10-B40, such as a square, a triangle, or a semi-circle.

The form of arrangement of the link bodies A is not limited to the form of arrangement at one linear edge B10-B40 of the board members B1 to B4 shown as an example. A form of arrangement at two linear edge B10-B40, a form of arrangement at the linear edge B10-B40 and the linear edge B11-B41, a form of arrangement at all of the linear edges B10-B40 and B11-B41, and the like can be shown as an example.

The present invention is not limited to the embodiment shown as an example. Implementation is possible with configurations not departing from the content described in each of the claims.

### REFERENCE SIGNS LIST

A Link body
A1 Link member
A2 Link member
A10 N pole surface (facing surface)
A11 S pole surface (facing surface)
A20 N pole surface (facing surface)
A21 S pole surface (facing surface)
A12 Linear edge
A22 Linear edge
B Whiteboard (folding structure)
B1 Board member (separating member)
B2 Board member (separating member)
B3 Board member (separating member)
B4 Board member (separating member)
C Storage recessed part
B10 Linear edge
B20 Linear edge
B30 Linear edge
B40 Linear edge
B11 Linear edge
B21 Linear edge
B31 Linear edge
B41 Linear edge
B12 Facing surface
B22 Facing surface
B32 Facing surface
B42 Facing surface
B13 Facing surface
B23 Facing surface
B33 Facing surface
B43 Facing surface

1. A board comprises:
a board member, and
two link members including a first link member and a second link member, and being magnet, wherein
the board member has a thickness that is substantially the same as a thickness of a photo-mount of an album,
the board member includes at least one linear edge at a peripheral edge,
two storage recessed parts are provided along only the one linear edge to store the two link members respectively,
the storage recessed parts are positioned separately (apart from each other) with line-symmetric about a center of the one linear edge,
the first link member is arranged to be a magnetic pole surface on a first surface of the board member, the magnetic pole surface of the first link member being a different polarity from a magnetic pole surface of the second link member on the first surface of the board member, and
the magnetic pole surface of the first link member on the first surface of the board member being a different polarity from a magnetic pole surface of the first link member on a second surface of the board member, the second surface of the board member being on an opposite side of the board member from the first surface of the board member.

2. A board set comprises:
two or more boards claimed in claim 1, wherein
the boards are arranged as to fit along the linear edges of the boards, to align the position of the link members of the boards and to link the link members,
two boards, adjacent to each other, of the two or more boards are relatively rotatable up to 360° centering around the linear edges,
the two or more boards are foldable by being overlapped,
the two boards, adjacent to each other, of the two or more boards are developable centering around the linear edges to any angle, and
each of the boards are separable from the board set by pulling apart the link members against the attracting force due to the magnetic force of the link members.

3. The board set according to claim 2, wherein the board set is any one of an album, a picture book, a picture-story book, a dry-erase board, a loose leaf file, and a binding notebook.
